(19) United States
(12) Patent Application Publication
(10) Pub. No.: US 2012/0089451 A1
(43) Pub. Date: Apr. 12, 2012

(54) Fixed Location Kiosk Device and Method for Updating a Social Networking Profile

(76) Inventors: Omar Alberto Serra Agramonte, Brooklyn, NY (US); Arno Drost, Hilversum (NL)

(21) Appl. No.: 12/902,279

(22) Filed: Oct. 12, 2010

(51) Int. Cl. G06Q 30/00; H04N 5/225; G06K 7/01

(52) U.S. Cl. 705/14.23; 705/14.1; 705/14.37; 340/10.42; 348/207.1; 348/E05.024

(57) ABSTRACT

Embodiments of the disclosed technology comprise a method and system for remotely uploading to a data feed of a user's social networking profile information about the user's physical location and goods or services associated with that location, and providing incentives to users to utilize such a system. The method and system uses personal identification cards which are recognizable by a wireless communication reader of a kiosk upon presentation of the card by a user. The user is identified based on a unique identifier on the card, and the user's social networking profile is updated with data specific to that particular kiosk. Upon identification of the user, credits may be transferred to the user's account via the kiosk.

### FIELD OF THE DISCLOSED TECHNOLOGY

The disclosed technology relates generally to social networking. More specifically, the disclosed technology relates to location-based updating of social networking profiles.

### BACKGROUND OF THE DISCLOSED TECHNOLOGY

Social networking and other networking tools have become an increasingly important part of professional and personal lives. Social networking has become a multi-billion dollar industry. At the time of this writing, the companies at the forefront of the social networking boom are, amongst others, Facebook, MySpace, and Twitter. Websites such as Facebook allow users to create individualized profiles through which they are able to communicate and stay connected with social acquaintances across the world. Typically, a user of a social networking interface may post text, upload pictures, send and receive messages, and join common interests groups. The reach of these social networking platforms is continuously expanding and innovating.

Recently, social networking sites have become more than just a way to stay in touch with friends. Businesses, artists, musicians and the like have begun to utilize social networking sites as a way to promote their product or service. Likewise, many third-party businesses have undertaken development of applications for individuals to use in conjunction with their profiles, that is, in conjunction with data associated with themselves on the social network, and at least partially accessible by those whom they choose to share it with. The applications work in conjunction with the host site's platform. Several major social networking platforms have released the source code for their respective sites, thus enabling third parties to integrate the social networking site into other sites and applications.

A more recent innovation is the ability for users to integrate social networking platforms into their mobile phones. Many mobile phones are capable of supporting applications which access a user's social networking profile and news feed remotely. Another trend is for users to continuously update their social networking profiles in real-time. Today there are applications for mobile phones which update a user's social networking profile based on his/her location. The application uses a mobile phone's data connection plan to approximate a user's location and to automatically post to a data feed on that user's social networking profile, in order to let friends know where the user is.

This technology has several shortcomings. First, many people, for reasons of income, age, or personal preference, do not have mobile phones. These users are only able to update their social networking profiles by way of a computer. Secondly, even people with cell phones may not be able to utilize such technology because either they have not subscribed to a data plan with their mobile provider, or their phone does not have the technical requirements needed to run the application.

Another recent innovation in social networking has been the introduction of virtual gifts to be exchanged between social networking contacts. Such gifts are available for purchase from the host social networking platform. The gifts typically cost around $1.00 each. However, in order to buy a gift, a user must first buy a token or some other web-based currency. A token may cost a user one U.S. dollar. The token itself, once purchased, has little or no cash value. The token may be exchanged for virtual gifts to be posted on a friend's social networking profile. For example, one may purchase a virtual birthday cake and post it on a friend's social networking profile for that friend's birthday. One social networking platform, Facebook, tested virtual gifts and ended up fully incorporating the service into its site because of the favorable response from its members. Such a service is exponentially profitable to the provider because the “goods” being purchased are virtual and require little overhead costs. In other words, once the virtual good is created, the provider does not have to reproduce or remanufacture it when it is sold, because the good is not a tangible item. However, one of the shortcomings of the service of providing virtual gifts via social networking platforms is that so many applications or ‘widgets’ are available to the user that there is less incentive to actually purchase a virtual gift. For example, a friend may choose to upload a video to a recipient's social networking profile for the recipient's birthday. Doing so costs the friend nothing and is more personal than merely giving a virtual gift to the recipient. Boundless other free options are available to users as an alternative to virtual gifts. Another shortcoming of virtual gifts is that users have little or no incentive for earning or paying for virtual currency, because such currency cannot be exchanged for tangible goods. The ability to redeem online currency for virtual gifts may not appeal to the consumer.

Accordingly, there exists the need for a method and system for remotely updating a social networking profile without requiring the use of a mobile phone, personal digital assistant, or notebook computer. Moreover, there exists a need for integrating product placement and awareness into the process of updating a user's social networking profile. Finally, there exists a need for a method and system which serve as an incentive to users by making such products available to them at a discount or free of charge.

### SUMMARY OF THE DISCLOSED TECHNOLOGY

The disclosed technology described herein addresses a need unfulfilled in the prior art by providing a method and system for remotely updating a social networking profile without requiring the use of a mobile phone, personal digital assistant, or notebook computer.

Accordingly, it is an object of the disclosed technology to provide a method and system by which users may update a social networking profile by placing a card within range of a radio frequency identifier (RFID) kiosk.

It is also an object of the disclosed technology to provide a system and method by which providers of goods or services may promote their product by providing a RFID kiosk and incorporating advertisements into the data being posted to a user's social networking profile.

It is a further object of the disclosed technology to provide a system of rewarding a user with credits when the user utilizes the kiosk, and allowing the credits to be used towards the purchase of goods or services.

Therefore, provided herein is a method and system for remotely uploading to a data feed of a user's social networking profile information about the user's physical location and, in embodiments, goods or services associated with that location, and providing incentives to users to utilize such a system. In an embodiment of the disclosed technology, a method follows the following steps. First, a plurality of personal identification cards is provided. Each personal identification card is associated with a data feed of an individual's social networking profile. Each personal identification card also has a unique identifier. Secondly, a communication reader of a kiosk is used to receive a unique identifier from one of the personal identification cards. In addition to a communication reader, the kiosk is also associated with data that is specific to the kiosk's location. Such data may include, but is not limited to, geographic data, data relating to a particular provider of goods or services, such as where the kiosk is located and data relating to a provider of goods or services not located on site. Next, the unique identifier identifies the particular social networking profile which correlates the personal identification card. The method proceeds when the location-specific data is augmented to the correlative social networking profile via a wide area network.

In an embodiment of a method of the disclosed technology, an additional step is provided. This step entails the transfer of one or more credits to an account associated with the personal identification card. The credits may then be used towards the purchase of goods or services at a physical location. In one embodiment of a method of the disclosed technology, the credits may be used towards the purchase of goods or services at the physical location at which the kiosk is located. Such a physical location may include a retailer of goods, a restaurateur, a service provider, or a non-retail location. In an alternative embodiment, the credits may only used at a physical location that is different from the physical location at which the kiosk is located.

In another embodiment of the disclosed technology a kiosk is disclosed. The kiosk's components include a display, a communication reader, and a wide area network connection. The communication reader is configured to wirelessly receive information from a personal identification card. The wide area network connection is configured to transmit instructions to a user which enables the user to add credits to his or her account. The credits may be used towards the purchase of goods at a plurality of locations. A social network profile associated with the user is augmented with data corresponding to the location of the kiosk based on the wireless receipt of information from the personal identification card.

The kiosk is placed at a first physical location and, in an embodiment of the disclosed technology, goods may be purchased at the first location, using redeemed credits. In yet a further embodiment, the display of the kiosk may include advertisements for goods or services. The credits may be used towards purchases at the same location at which the kiosk is placed, purchases made at a location separate from the location at which the kiosk is placed, or purchases made online via electronic interface accessible via a wide area network.

In an additional embodiment, a method of updating a social networking data feed follows the following steps. First, a data storage medium is provided which has data pertaining to a plurality of social networking accounts. The social networking accounts may be hosted by any social networking platform, and each account has a profile that is associated with a unique, corresponding individual. A “social networking profile,” for the purposes of this specification, is defined as an online data feed and interface hosted by a third party platform that has data associated with the individual, receivable by both input by the individual and others who are designated as friends or social contacts of the individual. Data associated with the social networking profile are also defined as being accessible to others who are designated friends or social contacts of the individual. An individual is vested with the ability to manipulate or control updates and changes to his or her social networking profile in order to personalize it. A “social networking platform,” for the purposes of this specification, is defined as a third party service/server which remotely hosts/stores individual profiles. Some examples of social networking platforms include Facebook, MySpace, Friendster, and Bebo.

Proceeding with the method, a plurality of personal identification cards is provided, each of which stores data in the form of a tag number therein. Next, each tag number is correlated in the data storage medium to a unique account. The account has personal information about an individual. A wireless communication reader is then provided which operates to wirelessly receive a tag number from one of the personal identification cards. “Wireless communication” in this specification may be any configuration which uses radio communication to transmit data over close ranges (e.g., radio frequency identification). The wireless communication reader is associated with location-specific data. The method proceeds with the wireless communication reader gathering the tag number from one of the personal identification cards and identifying the account to which the tag number correlates. The location-specific data is then relayed to a data feed associated with the correlating social networking profile. In a further embodiment, an additional step is included of transferring credits to the account. The credits are exchangeable at a physical location for the purchase of goods or services. In yet a further embodiment, the wireless communication reader is located at a first location, and the credits received are used for goods or services at a second location.

In yet another embodiment, a social media system is disclosed. The system's components include a plurality of personal identification cards and a device. The personal identification cards store data in the form of a tag number. The device is associated with data corresponding to a plurality of social networking accounts and social networking profile data associated with an individual. Each of the social networking accounts is associated with at least one tag number of the plurality of personal identification cards. The device also includes a wireless communication reader. The wireless communication reader operates to receive a tag number from one of the personal identification cards and relays location information to a data feed associated with the social networking profile which is associated with the card-bearing individual.

In further embodiments of the disclosed technology the kiosk may display additional information. In one embodiment, the additional information may be data exhibiting to a user the locations of other kiosks which are nearby. In another embodiment, additional information displayed may comprise the names of individuals who have previously presented a personal identification card to that particular kiosk. The names shown may be limited to those individuals who are associated with the current user by way of their social networking profile.

In still further embodiments of the disclosed technology, the kiosk may be connected to a camera which is operable to capture digital media from a user and augment the media to a social networking profile. The digital media may include image, audio, and video data. The media are augmented to the social networking profile in addition to the location-based and/or product data augmented.

In accordance with these and other objects, which will become apparent hereinafter, the disclosed technology will now be described with particular reference to the drawings.

### BRIEF DESCRIPTION OF THE DRAWINGS

FIG. 1 shows a high level drawing of a wireless communication reader system arrangement.

FIG. 2 is a high level drawing of the interaction between the RFID tag of the personal identification card and wireless communication reader in an embodiment of the disclosed technology.

FIG. 3 is a flow chart of an overview of a method of carrying out embodiments of the disclosed technology relative to the kiosk.

FIG. 4 is a flow chart of an exemplary overview of a method of carrying out embodiments of the disclosed technology relative to one individual.

FIG. 5 is a flow chart of an example of a user experience under a system of an embodiment of the disclosed technology.

FIG. 6 is an example of a visualization of a social networking profile with product information according to an embodiment of the disclosed technology.

FIG. 7 is a high level drawing of an exemplary system according to an embodiment of the disclosed technology.

FIG. 8 is a high-level block diagram of a bidirectional transceiver that may be used to carry out the disclosed technology.

A better understanding of the disclosed technology will be obtained from the following detailed description of the preferred embodiments taken in conjunction with the drawings and the attached claims.

### DETAILED DESCRIPTION OF EMBODIMENTS OF THE DISCLOSED TECHNOLOGY

Embodiments of the disclosed technology comprise a method and system for remotely uploading, to a data feed of a, or associated with, a user's social networking profile, information about the user's physical location and goods or services associated with that location, and providing incentives to users to utilize such a system. The method and system uses personal identification cards which are recognizable/readable by a communication reader of a kiosk, upon presentation of the card by a user. The user is identified based on a unique identifier on the card, and the user's social networking profile is updated with data specific to that particular kiosk. Upon identification of the user, credits may be transferred to the user's account via the kiosk.

Referring now to the drawings, which represent a method and system for updating a user's social networking profile via transmission of data from a personal identification card, the description of same is as follows.

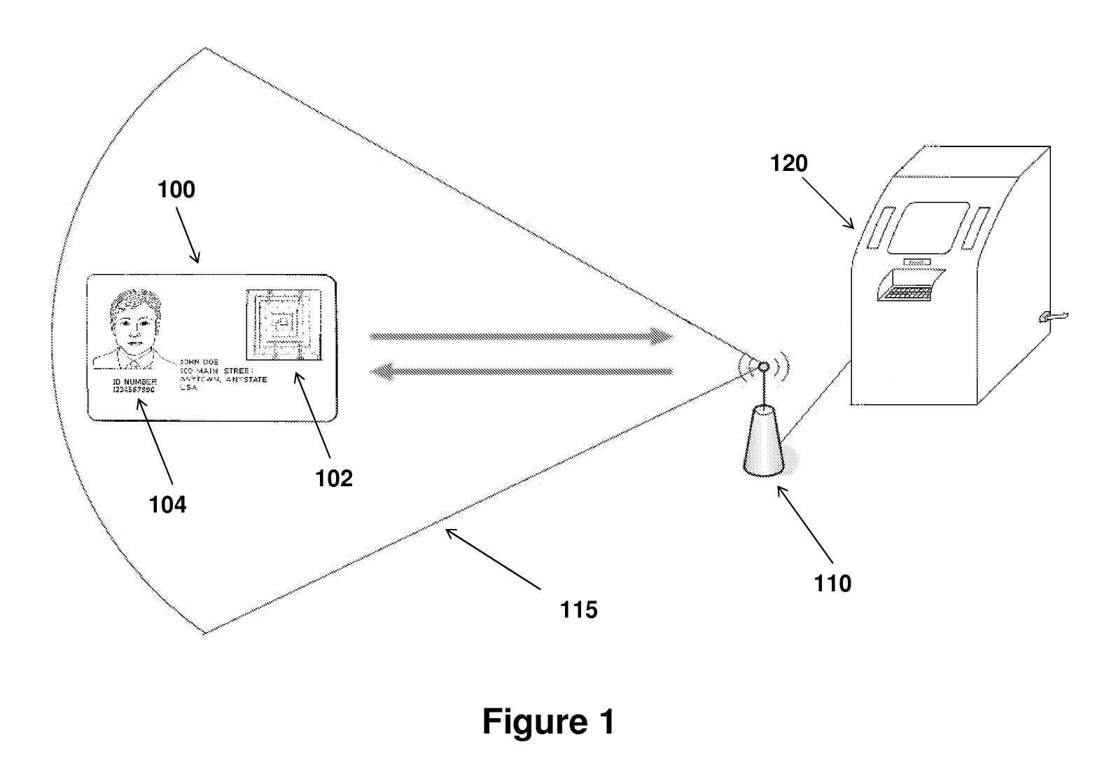

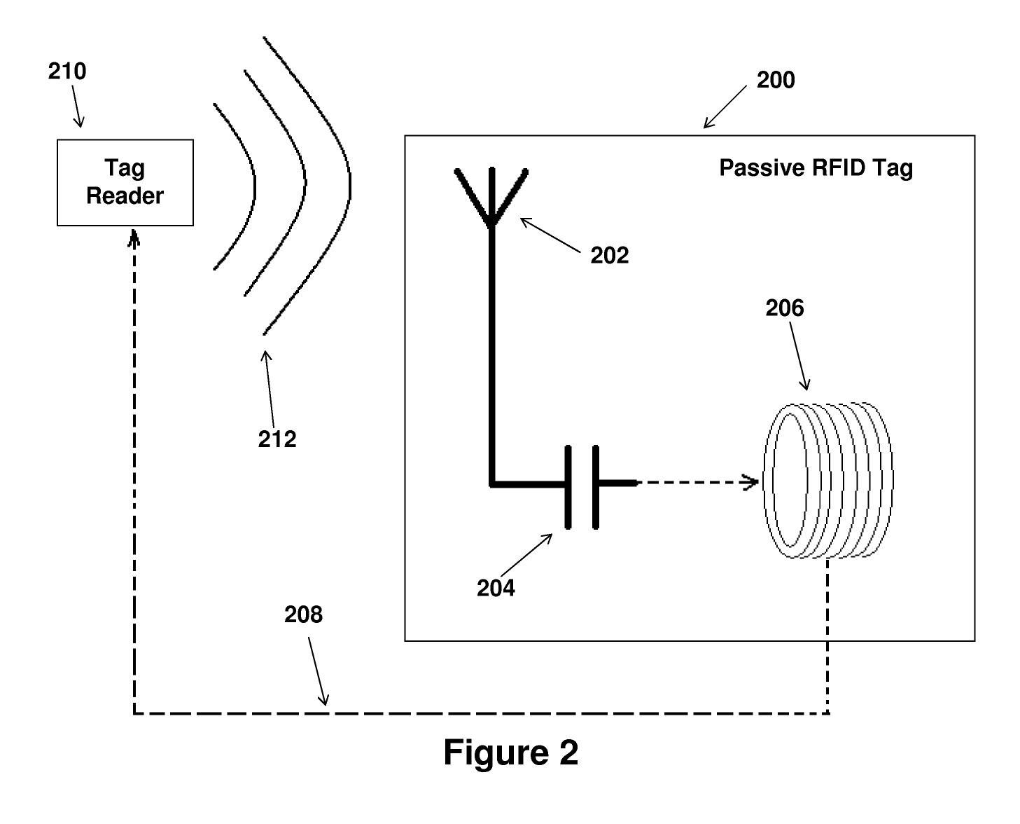

FIG. 1 shows a high level drawing of a wireless communication reader system arrangement. Any means of communication may be implemented. For example, the communication reader may be a magnetic swipe device which reads data stored on a magnetic stripe on a card (e.g., a credit card), RFID card reader (defined below), or another wireless communication method. For purposes of this disclosure, “wireless communication” refers to wireless radio communication which is the exchange of data via a radio frequency. The particular example shown in FIG. 1 shows an embodiment of the disclosed technology which uses an (RFID) system arrangement. This is the embodiment of the disclosed technology referred to in FIGS. 1 and 2. RFID involves the use of an object (typically, an RFID tag communicated via Near Field Communication [NFC]) applied to, or incorporated into, a housing, device, animal, or person for the purpose of identification and tracking, using radio waves. In RFID tagging, an information carrying device, or tag, functions in response to a coded radio frequency (RF) signal transmitted from a base station or tag reader. The RF carrier signal reflects from the tag and can be demodulated to recover information stored in the tag. The tag typically includes a semiconductor chip having RF circuits, logic, and memory, as well as an antenna. Various tag structures, circuits, and programming protocols are known in the art. Examples are described in U.S. Pat. No. 5,682,143 (Brady et al.) and U.S. Pat. No. 5,444,223 (Blama), both of which are incorporated herein by reference.

There are generally two types of RFID tags known in the art: passive RFID tags and active RFID tags. Passive RFID tags, unlike active ones, do not require a battery in order to transmit an RF signal frequency. Instead, passive RFID tags rely on an external source to provoke signal transmission. The tag reader/writer transmits the operating power for these tags. As a result, such passive RFID systems generally have a very limited transmission range. However, passive RFID tags may generally be manufactured to be smaller and thinner in size than active RFID tags, due to fewer parts being required. Also, passive tags do not contain a battery that must periodically be replaced. Thus, a passive RFID tag may be embedded in a card which is approximately the size of a credit card.

Most passive RFID systems work as follows. A reader emits an electromagnetic field for the purpose of powering the tag. A coil in the tag is powered by the electromagnetic field, causing the tag's circuitry to “wake up.” The tag uses this power to send an identifying signal back to the interrogator.

Although most passive RFID systems are “read-only” (that is, the tags in such system respond to a query by reading information from their memory and sending the information back to the interrogator), the tags used in some passive RFID systems have a limited ability to accept information and instructions from the interrogator, for example “read/write” capabilities in smart cards (electronic money) and “electronic manifests” in industrial applications.

Referring again to FIG. 1, RFID involves the use of an object (typically referred to as an RFID tag) applied to, or incorporated into, a housing for the purpose of identification and tracking using radio waves. An RFID tag 102 is shown in FIG. 1. The RFID tag 100 is embedded in an identification-type card 100, such as a 3″ by 5″ flat card, credit card size card, a keychain housing, or any other portable medium which may be contemplated. For the purposes of this specification, the RFID tag and any housing will be collectively referred to as “personal identification card,” or “card,” which is understood to communicate via short range radio communication, such as near-field communication (NFC). The personal identification card 100 is issued to a user and is used to identify the user's personal account and social networking profile. In an embodiment of the disclosed technology, the RFID tag 100 contains read-only data in the form of a unique identifier 104. The unique identifier 104 may be a tag number or anything else that serves to indicate and identify the owner of the card. The identifier is unique to the card and therefore to the holder, and is used to identify the card holder for the purposes of sending data to a social network profile and managing a user's account.

Referring still to FIG. 1, a kiosk 120 with a wireless communication reader 110 is shown. As alluded to previously, other means for communicating with a personal identification card may be implemented. For the purposes of this specification, a “kiosk” is any fixed location device (that is, the location of an active kiosk is always known) which is configured with a communication reader (“reader”) for receiving information from a personal identification card. The kiosk 120 may, for instance, be located in a retail location or on a college campus. The kiosk's components may include a display, a wireless communication reader, and a wide area network connection. Additionally, the kiosk may further include a camera (not shown). The camera is operable to capture digital media of the kiosk's users. The digital media may include image, video, and audio data, such data being used to augment a social networking profile of a user. The reader 110 works by emitting radio frequency signals to a predisposed area 115 in the general vicinity around the kiosk. When a compatible personal identification card 100 comes within range of the reader, the reader is able to read the data stored on the card. The kiosk 120 associates the unique identifier stored on the card with a social networking profile and account, the account comprising data stored on a third party server. The server is remotely located, and it may communicate with the reader/writer through a local area network, a wide area network, wireless local area network, or any other method for exchanging data remotely.

FIG. 2 is a high level drawing of the interaction between the RFID tag of the personal identification card and wireless communication reader in an embodiment of the disclosed technology. The disclosed technology of FIG. 2 employs the use of passive RFID tags, which are well known in the art. A passive RFID tag does not comprise, i.e., is without, a battery, unlike active RFID tags. This enables the passive RFID tags to last longer and to be manufactured in a much smaller size. With reference to FIG. 2, a typical passive RFID tag arrangement 200 comprises, or consists of, an antenna 202, capacitor 204, antenna coils 206, and encoded data, that is, a string of stored data. When the tag 200 comes within range of a reader 210, the reader broadcasts an electromagnetic radio signal 212 to the tag. The antenna 202 in the tag 200 receives the signal and stores a charge in the capacitor 204. When the capacitor 204 has built up sufficient energy, it releases it to the tag's coils 206. Using the provided energy, the tag's coils release encoded radio waves 208 containing the data stored in the tag. The reader 210 receives the encoded waves 208 and demodulates them. The whole process can occur within milliseconds, i.e., be almost instantaneous. The bridge between the tag and the tag reader/writer forms an invisible electromagnetic circuit of sorts.

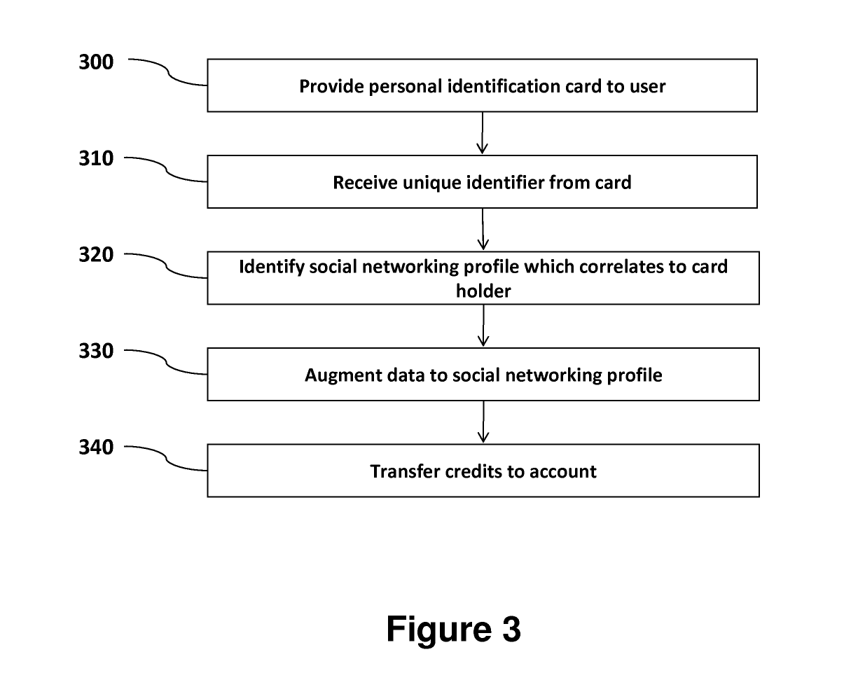

FIG. 3 is a flow chart of an overview of a method of carrying out embodiments of the disclosed technology relative to the kiosk. In an embodiment of the disclosed technology, a method follows the following steps. The method begins in step 300 when a plurality of personal identification cards is provided to users, and, as such, each user has his/her own personal identification card. As discussed with respect to FIG. 2, each card has a unique identifier which is associated with the user's social networking profile. A “social networking profile,” for the purposes of this specification, is defined as an online interface hosted by a third party platform that is representative of an individual and exhibits that individual's corresponding social connections or friends. An individual is vested with the ability to manipulate or control his or her social networking profile in order to personalize it. The social networking profile is located remotely on a server and may be hosted by any social networking platform. A “social networking platform,” for the purposes of this specification, is defined as a third party service/server on which individual profiles are stored and may be manipulated. Some examples of social networking platforms are Facebook, MySpace, Friendster, and Bebo. Each personal identification card is associated with a data feed of an individual's social networking profile. A data feed on a social networking profile is a customizable portion of a user's profile onto which the user and other individuals may make postings in real time. The postings may include text, images, videos and hyperlinks. Each personal identification card also contains or comprises a unique identifier.

A “unique identifier,” for the purposes of this specification, may be anything that can be used to identify an individual. For example, a tag number, a barcode, or magnetic strip may be implemented in order to identify a specific, unique individual. The method proceeds in step 310. A wireless communication reader of a kiosk receives a unique identifier from one of the personal identification cards. In addition to a wireless communication reader, the kiosk also comprises data which is specific to the kiosk's location. Such data may include, but is not limited to, geographic data, data relating to a particular provider of goods or services at which the kiosk is located and data relating to a provider of goods or services not located on site/located at a distinct or separate location. A location, for purposes of this disclosure, is defined as one of the following: a) a place that has four walls separating it from anything outside the four walls; b) a retail space rented or owned by a distinct individual or corporate entity, whether indoors or outdoors, which sells products or services. A location owned or operated by a corporate entity may be, for example, a mall, a university, or a museum. Such a location must be known with specificity for augmenting a social networking profile with such data. If a kiosk is moved to a new defined location, this new location must be associated with the kiosk in order for the method of the disclosed technology to function properly.

Next, in step 320, the unique identifier is used to identify the particular social networking profile which correlates the personal identification card. The method proceeds with step 330 when the location-specific data associated with the kiosk is augmented with the correlative data feed of the associated social networking profile via a wide area network. The location-specific data may include the name of a retail location (e.g., McDonalds) or the name of a physical address or geographic location (e.g., New York, N.Y.). The data may also include information about the products or services offered at or near a particular kiosk location. Most social networking platforms have released their source code, allowing third parties to manipulate data feeds associated with a profile. Furthermore, many web-based social network applications have application programming interfaces (hereinafter “API”) by which other software may interact with that of the social networking platforms. API's work to access data and core functions of social networks. An API may be implemented in a method or system of an embodiment of the disclosed technology in order to enable augmentation of data to a social network data feed. The post, or added information on the social networking data feed (the augmented data feed), may include data about the user's geographic whereabouts, the store/place where the user is presently located, the product(s) or service(s) provided at that location, or any other information relevant to an advertisement or to the user and his/her location. The post may further include digital media recorded by the kiosk. Such media may be in the form of videos, images, and audio recordings captured from a camera connected to the kiosk. For example, a user may choose to upload a photo of himself at the particular location of the kiosk, in order to make his/her posting more personalized in communication with friends.

This system enables the user to automatically update his/her social networking profile without logging into their account and without even accessing a computer, personal digital assistant, mobile phone, or any other electronic device. The system merely requires that the user be in possession of his/her personal identification card.

Referring still to FIG. 3, the embodiment shown comprises an additional step of transferring credits to a user's account. “Credits,” for the purposes of this specification, may be actual dollars added to an account balance, a coupon or discount (e.g., 20% off at store X), or a virtual/online currency which has no direct monetary value (i.e., tokens or points). If virtual “tokens” or “points” are issued to a user's account, they may be redeemable upon presentation of the card at a point of sale, at a physical location, or at an electronic interface for making an online purchase.

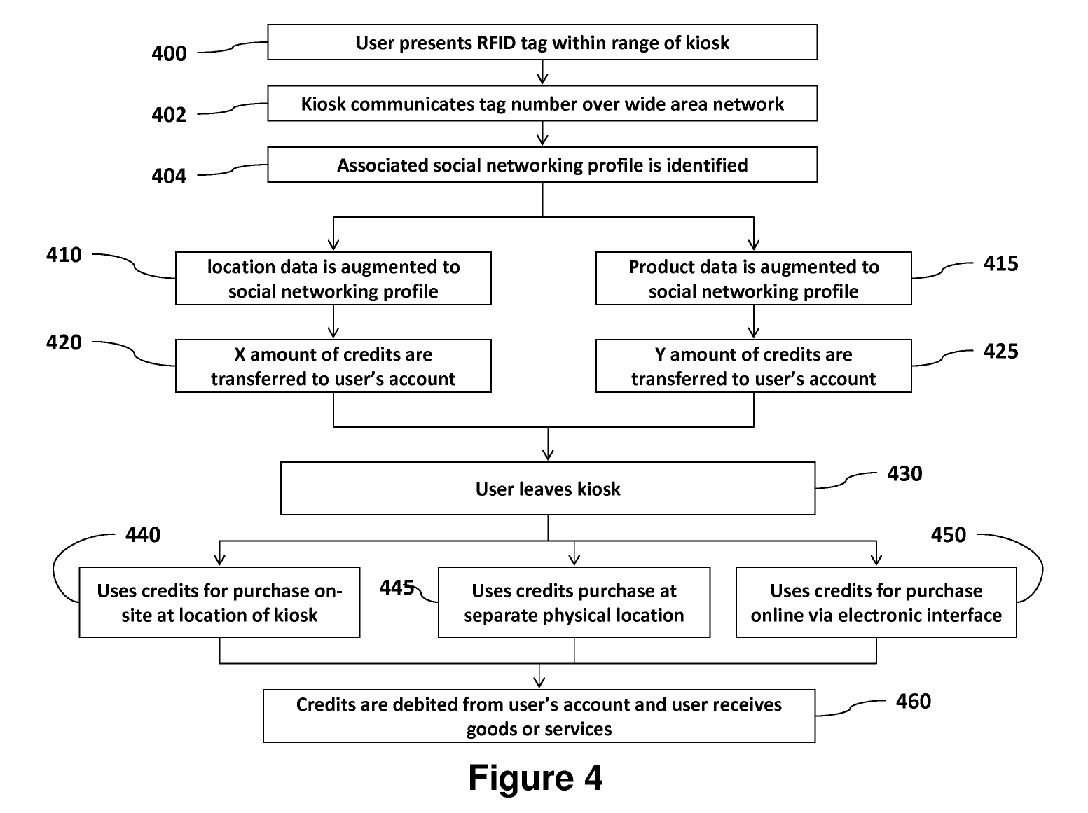

FIG. 4 is a flow chart of an exemplary overview of a method of carrying out embodiments of the disclosed technology relative to one individual. As previously discussed, the user is issued a personal identification card associated with an account and corresponding social networking profile. The steps shown in FIG. 4 illustrate an embodiment of the disclosed technology from the standpoint of a card-holding individual. The method begins in step 400 when the user presents the card within range of the kiosk's reader. The kiosk may be physically located anywhere, such as at a location of a retail store or a specific, defined location within a college campus, such as at a student center, entrance to a dormitory, entrance to a classroom or building of classrooms, or the like. Furthermore, the kiosk may have advertisements for goods that can be bought at the particular location of the kiosk, or related goods which can be purchased elsewhere. For example, a kiosk may be placed at a location of a clothing store, but may have advertisements for a shoe store that sells shoes with styles appropriate to the apparel sold at the clothing store. The kiosk may even initiate or cause the transfer of credit or a coupon to a user's account that is only redeemable at that particular shoe store, and display information about the location of the shoe store.

In step 402, the tag information is sent to a server via the wide area network. Next, in step 404, a social networking profile is identified based on the kiosk reading data from the user's identification card. That is, the kiosk transmits such receipt of data from the user's identification card (and in embodiments, video, audio, and other data) to a remote location over a wide area network (e.g., the Internet). An optional step (not shown) of the user confirming the identity of his or her social networking profile upon recognition by the reader of the card may also be implemented. From there, in steps 410 and 415, the data is processed and sent, such as via an application programming interface (API) to an online social network where the data is appended to the social networking profile associated with the user. That is, such data is now available to those friends and colleagues with access, to view this update of status of the user, based on viewing of his or her social networking profile via an interface associated with the social network. An API enables the content associated with the particular kiosk to be “translated” in order to interact with a given social network.

The embodiment shown in FIG. 4 shows two alternative sequences. Step 410 shows location data being augmented to a user's social networking profile (i.e., geographic location, “Midtown Mall”). Alternatively, step 415 shows product information being augmented to the social networking site. Each step (410 and 415) results in the remote transfer of a certain amount of credits to the user's account. For example, a user may be rewarded with more credits under step 425 because the user is promoting a particular product being advertised. The method proceeds with step 430 in which the user leaves the kiosk with the credits having been transferred to his or her account. The credits may now be taken to a physical location to be used for the purchase of goods or services (steps 440 and 445). Step 450 shows how the system may also be configured to allow the use of credits at online retailers towards purchases made via electronic interfaces. Such credits are redeemable in similar fashion to coupon/promotional code redemption, in which a user enters a particular number or code at an online checkout. Steps 440 and 450 show alternative avenues for using the credits, and each has its own particular advantages. Step 440 allows the user to redeem the credits at the particular store at which the user presented the card to the kiosk. This allows retailers to promote their product by providing incentives for individuals to use the card because they will get a discount on their purchase. When the card is used, information with the retailer's name, location, or product will be uploaded to a public social networking profile which will be visible by others. Step 445 involves the transfer of credits that are redeemable at another physical location (i.e., not the one at which the kiosk is placed). Under this arrangement, different retailers may form agreements to advertise each others' products in their stores based on similarities between their products. For example, a store which deals exclusively in athletic shoes may have a kiosk placed within its store. Upon presenting the card at this particular kiosk, credits may be transferred to a user's accounts which are redeemable at a sporting goods store in the same strip mall.

An additional feature of an embodiment of the disclosed technology may be the display of names of previous users/friends/connections in a social network to the current user via the kiosk. After a user presents his/her card to a kiosk, information may be displayed on the kiosk identifying others who have used the kiosk before the user. The names of individuals may be limited only to those previous users who are socially connected with, or friends of, the current user, or are in the same social network as the current user. The information displayed may also include the particular date and time when the previous user utilized the kiosk.

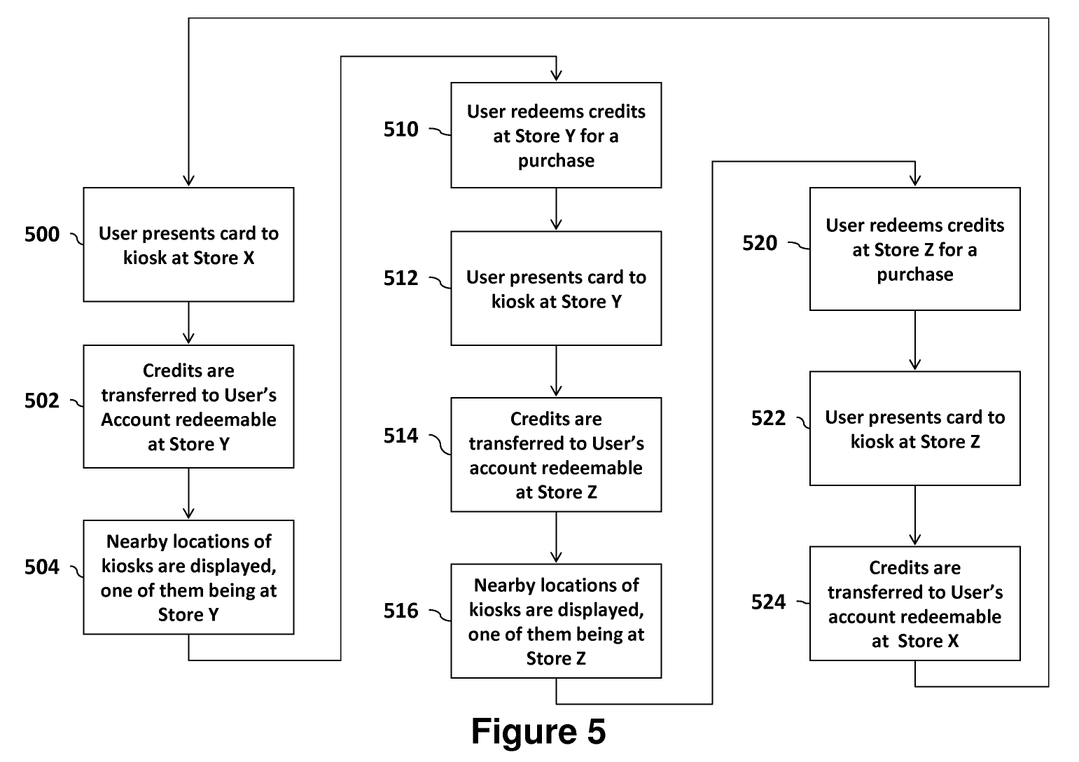

FIG. 5 is a flow chart of an example of a user experience under a system of an embodiment of the disclosed technology. This example demonstrates the system's utilization for leading consumers to make purchases at two or more retailers based on similarities between the retailers. In the example shown, step 500 shows a user presenting the card to a first kiosk at a store X. Upon presenting the card, in step 502, the credits are transferred to the user's account for use at a store Y. Store Y may have products or services similar or dissimilar to those offered at store X. Moreover, store Y may appeal to a similar demographic group. In receiving credits, the user now has an incentive to proceed to store Y to redeem the credits. In order to help facilitate the user's procession to store Y, in step 504 nearby locations of other kiosks may be displayed to the user via the kiosk, one of those kiosks being located at store Y. The user then proceeds to store Y, and in step 510 redeems the previously transferred credits to make a purchase. While at store Y, the user also presents the card to a kiosk located therein (step 512). Under step 514, more credits are transferred to the user's account, these credits being redeemable at a store Z. Likewise, store Z may appeal to the same demographic group as stores X and Y. Once again, the nearby locations of store Z, in which there is another kiosk (step 516), may be displayed on the kiosk. The user now has an incentive to proceed to store Z to make a purchase using the newly acquired credits (step 520). Once again, under step 522, the user presents his/her card to the kiosk located at store Z. Likewise, credits are transferred to the user's account. However, in this example, the credits are redeemable at store X. Step 524 exemplifies the ability of two or more retailers to utilize the system of the disclosed technology to lead consumers to each others' locations. For example, stores X, Y and Z may have a reciprocity agreement, using the kiosk, whereby they can direct consumers to and from their respective locations. The system may be configured such that the kiosk at X sends users to Y, the kiosk at Y sends users to Z, the kiosk at Z sends users back to X, and so forth.

In embodiments of the disclosed technology, a social networking system is operated by a host company/third party which provides and maintains all of the kiosks. The host company has individual contracts/relationships with the particular locations of the kiosks. As described, such locations may be retail stores, but may also include universities, museums, etc. The host company also provides the remote server which acts as the central repository for all of the kiosks. In this embodiment, credits may be redeemed on an online interface hosted by the company towards the purchase of goods. The online interface may have goods and services for sale that are provided by one or more third party retailers pursuant to a given arrangement. In this embodiment, any credits received are associated with the host company, therefore redemption of the credits is possible at a point of sale provided by the host company (i.e., an online electronic interface) or at a retail location which accepts credits issued by the kiosk provider.

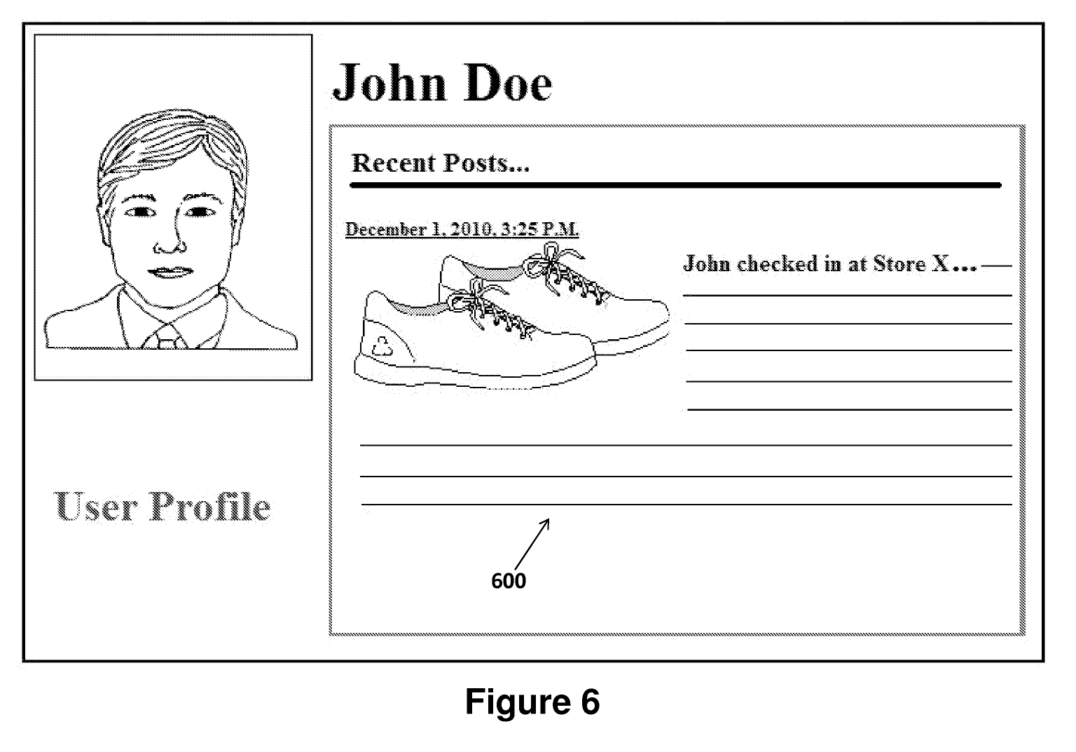

FIG. 6 is an example of a visualization of a social networking profile with product information according to an embodiment of the disclosed disclosure. It shows an example of a typical social networking profile associated with an individual. This individual is the account holder and card holder. Upon presenting a personal identification card to a kiosk, a posting 600 such as the one shown in FIG. 6 is augmented to a data feed found on the social networking profile. The contents of the posting may include date, time, geographic location, retail location, product information, or any other indicia which serve to identify the locale of that particular kiosk. Such a posting will be visible to all social networking accounts or individuals who have access to that particular social networking profile. It presents an advertiser's name and location to an vast body of potential consumers with little cost.

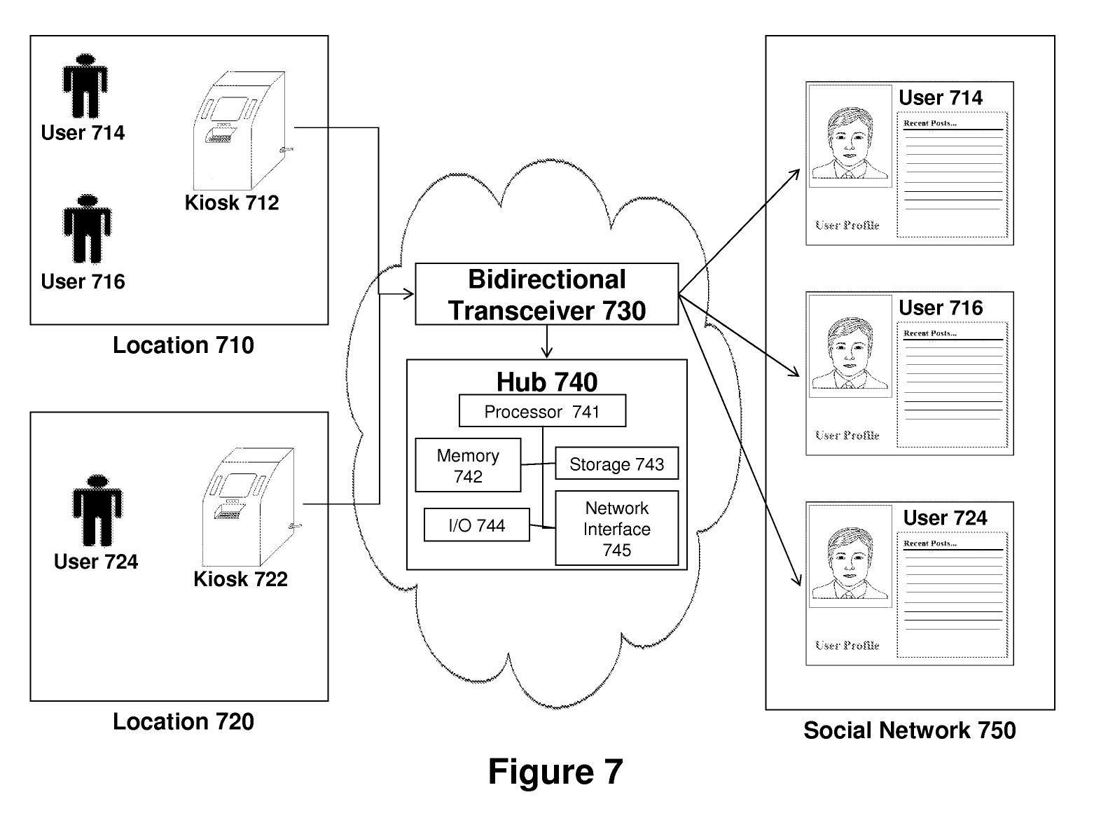

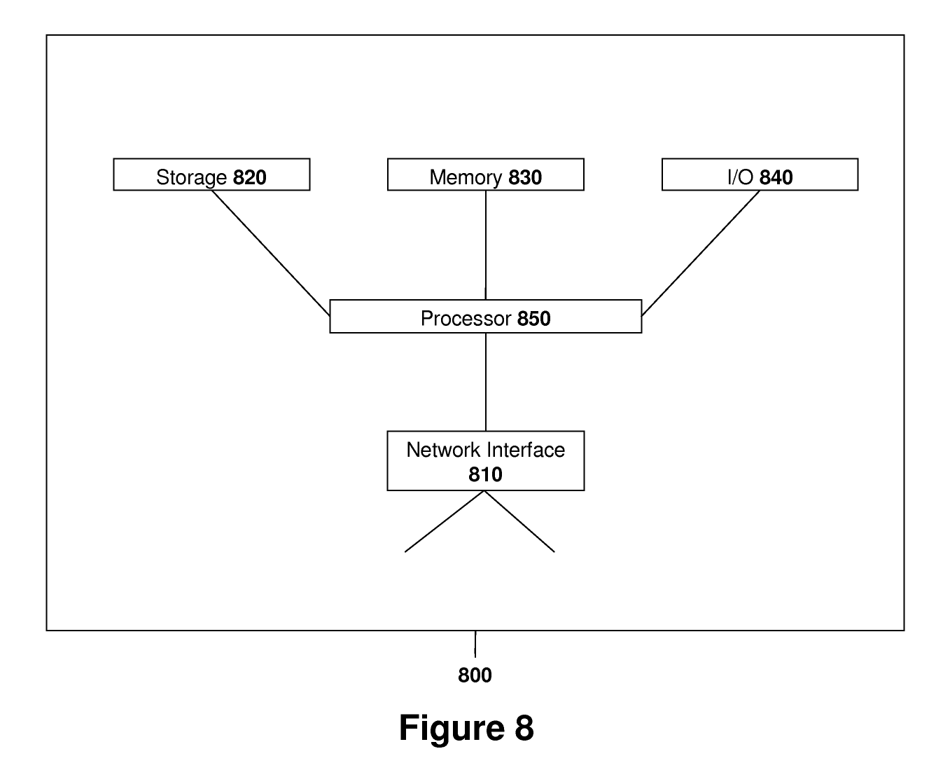

FIG. 7 is a high level drawing of an exemplary system arrangement according to an embodiment of the disclosed technology. FIG. 7 gives a general overview of how a system may be arranged and the process of updating a social networking profile. In this example, two locations, Location 710 and Location 720 are shown. As discussed, the locations may take any form, such as, but not limited to, a store, a college campus, a museum, a bowling alley, etc. Kiosks 712 and 722 are provided within each of the respective locations. Users 714 and 716 are shown to be present at Location 710. User 724 is shown to be present at Location 720. Users 714 and 716 present their cards to Kiosk 712 according to a method of the disclosed technology. Likewise, User 724 presents his or her card to Kiosk 722 according to a method of the disclosed technology. Upon receiving the corresponding unique identifiers, each of the kiosks transmits the identifying data to a bidirectional transceiver 730. The bidirectional transceiver 730 is a central repository for all of the accounts associated with card holders. The bidirectional transceiver 730 receives from the kiosks the unique identifiers. From there, the corresponding social networking profiles for the respective users are updated. When the unique identifier is received, as noted above, social networking profiles associated with the users are identified and correlated using a hub 740. In an embodiment thereof, a hub 740 comprises a processor 741, memory 742, input/output 743, storage 744, and a network interface 745. These features correspond to those described in further detail below with regard to FIG. 8 and the description thereof, below. In the embodiment shown in FIG. 7, when a user presents a unique identifier passing through the bidirectional transceiver 730, a social networking profile with corresponding API and location-based data is identified, using the hub 740. The location-based data is then transmitted to social network 750 using the bidirectional transceiver 730. The data transmitted is then augmented to the corresponding social networking profiles of users 714, 716, and 724. The social networking profiles are stored and hosted on a third party server provided by a social networking platform. As discussed, the bidirectional transceiver 730 is capable of interacting with the social network 750 by way of an API.

FIG. 8 is a high-level block diagram of a bidirectional transceiver that may be used to carry out the disclosed technology. Bidirectional transceiver 800 comprises a processor 850 that controls the overall operation of the computer by executing the transceiver's program instructions which define such operation. The transceiver's program instructions may be stored in a storage device 820 (e.g., magnetic disk, database) and loaded into memory 830 when execution of the console's program instructions is desired. Thus, the transceiver's operation will be defined by the transceiver's program instructions stored in memory 830 and/or storage 820, and the console will be controlled by processor 850 executing the console's program instructions. A bidirectional transceiver 800 also includes one or a plurality of input network interfaces for communicating with other devices via a network (e.g., the Internet). The transceiver 800 further includes an electrical input interface for receiving power and data from a power or RFID source. A transceiver 800 also includes one or more output network interfaces 810 for communicating with other devices. Bidirectional transceiver 800 also includes input/output 840 representing devices which allow for user interaction with a computer (e.g., display, keyboard, mouse, speakers, buttons, etc.). One skilled in the art will recognize that an implementation of an actual device will contain other components as well, and that FIG. 8 is a high level representation of some of the components of such a device for illustrative purposes. It should also be understood by one skilled in the art that the method and devices depicted in

FIGS. 1 through 7 may be implemented on a device such as is shown in FIG. 8.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1) A method comprising:
providing a plurality of personal identification cards, wherein each said personal identification card is associated with a corresponding data feed of a social networking profile, and each said personal identification card comprises a unique identifier;
receiving, to a wireless communication reader of a kiosk, a unique identifier from a first personal identification card of said plurality of personal identification cards, wherein said kiosk is associated with location-specific data;
identifying a said social networking profile correlating to said personal identification card; and
augmenting said location-specific data via a wide area network connection to said social networking profile.

2) The method of claim 1, further comprising a step of transferring one or more credits to an account associated with said first personal identification card, said credits exchangeable at a physical location towards a purchase of goods or services.

3) The method of claim 2, wherein said wireless communication reader is located at the physical location where said credits are used towards said purchase of goods or services.

4) The method of claim 2, wherein said wireless communication reader is located at a first physical location, and said credits are used towards purchase of goods or services at a second physical location.

5) The method of claim 4, wherein said first physical location is a non-retail location.

6) The method of claim 2, further comprising a step of displaying to said user one or more nearby locations of other kiosk.

7) The method of claim 1, further comprising a step of displaying one or more names of individuals associated with said user, who have checked in at said kiosk within a predetermined time range.

8) The method of claim 1, said method further comprising the following steps:
recording said user with a camera connected to said kiosk; and
augmenting media data captured from said camera to said social networking profile along with said location-specific data.

9) A kiosk placed at a first location, said kiosk comprising:
a display;
a communication reader configured to wirelessly receive information from a personal identification card; and
a wide area network connection configured to transmit instructions operable to add credits to an account of a user associated with said personal identification card upon receipt of said information, said credits redeemable for purchase of goods at a plurality of locations,
wherein a social network profile associated with said user is augmented with data corresponding to said first location of said kiosk based on said wireless receiving of said information.

10) The kiosk of claim 9, wherein goods are purchasable at said first location using said credits.

11) The kiosk of claim 10, wherein said display further comprises advertisements for goods or services.

12) The kiosk of claim 10, wherein said credits are redeemable towards the purchase of goods or services at the physical location at which said kiosk is placed.

13) The kiosk of claim 10, wherein said credits are redeemable towards the purchase of goods or services at a distinct location separate from said location at which said kiosk is placed.

14) The kiosk of claim 13, wherein said credits are redeemable for purchase of goods via an electronic interface accessible via said wide area network, said interface associated with a third party retailer of goods.

12) The kiosk of claim 9, further comprising a camera, said camera operable to record digital media; said digital media augmented to said social networking profile via said wide area networking.

13) The kiosk of claim 9, wherein information pertaining to one or more nearby locations of other kiosks is displayed via said kiosk.

14) The kiosk of claim 9, wherein one or more names of individuals associated with said user who have checked in at said kiosk within a predetermined time range are displayed via said kiosk.

15) A method of updating a social networking data feed comprising the steps of:
a. providing a data storage medium further comprising data representative of a plurality of social networking accounts, wherein each social networking account is associated with a unique, corresponding individual and social networking profile associated with said individual;
b. providing a plurality of personal identification cards further comprising stored data, said stored data comprising a tag number;
c. correlating, in said data storage medium, each personal identification card of said plurality of personal identification cards with a tag number so that each personal identification card is associated with a unique account; wherein said account contains personal information;
d. providing a wireless communication reader operable to receive a tag number from a personal identification card of said plurality of personal identification cards, said wireless communication reader comprising location-specific data;
e. gathering said tag number from one or more of said personal identification cards and identifying a said account which is correlative to said tag number; and
f. relaying said location-specific data to a data feed associated with a said social networking profile.

16) The method of claim 11, further comprising a step of transferring one or more credits to a said account, said credits exchangeable at a physical location for the purchase of goods or services.

17) The method of claim 12, wherein said wireless communication reader is located at the same physical location at which said credits are used towards the purchase of goods or services.

18) The method of claim 12, wherein said wireless communication reader is located at a first physical location, and said credits are used towards purchase of goods or services at a second physical location.

19) The method of claim 15, further comprising a step of displaying data selected from the group consisting of:
data directed to one or more nearby locations of other kiosks, and
data directed to one or more names of individuals associated with said user who have checked in at said kiosk within a predetermined time range.

20) The method of claim 15, said method further comprising the following steps:
recording said user with a camera connected to said kiosk; and
augmenting media data captured from said camera to said social networking profile along with said location-specific data.
